(19) United States
(12) Patent Application Publication
(10) Pub. No.: US 2026/0209955 A1
(43) Pub. Date: Jul. 23, 2026

(54) ELECTROLYZER OPERATION BASED ON PRESSURE CONTROL AND SYSTEM LEVEL RECYCLE BLOWER FOR MULTIPLE HYDROGEN GENERATION MODULES

(71) Applicant: BLOOM ENERGY CORPORATION, San Jose, CA (US)

(72) Inventors: Ali ZARGARI, Santa Clara, CA (US); Jayakumar KRISHNADASS, Santa Clara, CA (US); Alireza SAEEDMANESH, San Jose, CA (US)

(21) Appl. No.: 19/034,767

(22) Filed: Jan. 23, 2025

(51) Int. Cl. C25B 1/042; C25B 9/73; C25B 15/029; C25B 15/08

(52) U.S. Cl. CPC C25B 1/042; C25B 9/73; C25B 15/029; C25B 15/087

(57) ABSTRACT

A method of operating an electrolyzer system includes providing steam to a plurality of hydrogen generation modules (HGMs), each containing at least one electrolyzer cell stack or column of stacks, electrolyzing the steam in the plurality of HGMs to generate hydrogen and oxygen, supplying at least a first portion of a hydrogen-containing product feed from the plurality of HGMs to a recycling conduit, and recycling at least a first portion of the hydrogen-containing product feed to the plurality of HGMs.

### FIELD

The present disclosure relates generally to electrolyzer systems and operating methods, and more particularly to methods and designs for improving efficiency within electrolyzer systems while lowering operational costs.

### BACKGROUND

Hydrogen has gained popularity across the world as a source of clean energy with applications, for example, in transportation, stationary power, aviation, shipping, and more. When used as a fuel for a fuel cell system, the only by-products of the reaction are electricity, heat, and water, demonstrating the dramatic potential for emissions reductions across market sectors. In addition to decarbonizing these end-use applications, there is work underway to reduce the carbon intensity of hydrogen production itself. These methods include producing hydrogen from biomass or biomethane, as well as using renewable electricity from wind or solar power to power an electrolyzer. Electrolysis is the process of using electricity to split water into its component parts of hydrogen and oxygen. That hydrogen can then be stored for later use as fuel in a fuel cell vehicle, to power a stationary fuel cell system, or for power-to-gas applications. Using hydrogen to store excess power generated from renewables has shown great potential. For example, according to the International Renewable Energy Agency, renewable hydrogen produced from electrolysis is projected to grow rapidly, citing a current growth trend from megawatt to gigawatt scale in many countries.

The electrolysis of water occurs through an electrochemical reaction that does not require external components or moving parts. It is very reliable and can produce ultra-pure hydrogen (>99.999%) in a non-polluting manner when the electrical source is renewable energy.

The hydrogen produced from an electrolyzer is ideal for use with hydrogen fuel cells. The reactions that take place in an electrolyzer are very similar to the reaction in fuel cells, except the reactions that occur in the anode and cathode are reversed. In a fuel cell, the anode is where hydrogen gas is consumed, and in an electrolyzer, the hydrogen gas is produced at the cathode. Ideally, the electrical energy needed for the electrolysis reaction may come from renewable energy sources such as wind, solar or hydroelectric sources. Electrolyzers are useful and ideal when incorporated into certain stationary, portable, and transportation power systems. Some examples of applications in which electrolyzers would be particularly advantageous are long-term field use, fuel cell-powered vehicles, and portable electronics. A sufficient amount of hydrogen can be generated before it is used, and therefore, could be a beneficial addition to a system, for example, that uses solar and wind power. Electrolysis has the potential to meet the cost requirements specified by many governments around the world.

SOEC systems can be configured to operate by using individual steam controller valves configured for each hydrogen generation module (HGM). SOEC systems can contain multiple HGMs, and HGMs can be arranged into hydrogen building blocks (HBBs). For example, one HBB can comprise four HGMs. In addition, hydrogen (H₂) is characteristically fed and controlled by a mass flow controller for each individual HGM. This arrangement may prove costly due to the amount and type of equipment employed with the design.

### SUMMARY

According to an aspect of the present disclosure, an electrolyzer system comprises a plurality of hydrogen generation modules (HGMs), each containing at least one electrolyzer cell stack or column of stacks configured to electrolyze steam to generate hydrogen and oxygen; a steam supply conduit configured to provide steam from a steam source to the plurality of HGMs; a hydrogen supply conduit configured to provide hydrogen from a hydrogen source to the plurality of HGMs; a recycling conduit configured to recycle at least a first portion of the hydrogen-containing product stream from the plurality of HGMs back to the plurality of HGMs; and a product conduit configured to receive a second portion of the hydrogen-containing product stream from the plurality of HGMs. The system also comprises at least one of: (a) a primary recycle blower located on the recycling conduit outside of the plurality of HGMs and configured to recycle at least the first portion of the hydrogen-containing product stream from the plurality of HGMs back to the plurality of HGMs through the recycling conduit; (b) a steam pressure regulator located on the steam supply conduit and configured to control steam flow to the plurality of HGMs using pressure control; or (c) an orifice located on the hydrogen supply conduit and configured to control hydrogen flow through the hydrogen supply conduit to the plurality of HGMs.

According to another aspect of the present disclosure, a method of operating an electrolyzer system includes providing steam to a plurality of hydrogen generation modules (HGMs), each containing at least one electrolyzer cell stack or column of stacks, electrolyzing the steam in the plurality of HGMs to generate hydrogen and oxygen, supplying at least a first portion of a hydrogen-containing product feed from the plurality of HGMs to a recycling conduit, and recycling at least a first portion of the hydrogen-containing product feed to the plurality of HGMs.

### BRIEF DESCRIPTION OF THE DRAWINGS

The accompanying drawings, which are incorporated herein and constitute part of this specification, illustrate example embodiments of the invention, and together with the general description given above and the detailed description given below, serve to explain the features of the invention.

FIGS. 1A and 1B illustrate a schematic diagram of an HBB level solid oxide electrolyzer cell (SOEC) system configured to operate based on pressure control according to one embodiment of the present disclosure.

FIG. 1C illustrates a perspective view of an HBB including a plurality of HGMs and other modules of the system of FIG. 1B located on a common base according to one embodiment of the present disclosure.

FIG. 2 illustrates an HGM of the system of FIG. 1 according to one embodiment of the present disclosure.

### DETAILED DESCRIPTION

It is to be understood that the foregoing general description and the following detailed description are exemplary and explanatory only and are not restrictive of any subject matter claimed. In this application, the use of the singular includes the plural unless specifically stated otherwise. As used in the specification and the appended claims, the singular forms “a,” “an” and “the” include plural referents unless the context clearly dictates otherwise. In this application, the use of “or” means “and/or” unless stated otherwise. Furthermore, use of the term “including” as well as other forms, such as “include”, “includes,” and “included,” is not limiting.

For purposes of the present disclosure, the term “comprising”, the term “having”, the term “including,” and variations of these words are intended to be open-ended and mean that there may be additional elements other than the listed elements.

For purposes of the present disclosure, directional terms such as “top,” “bottom,” “upper,” “lower,” “above,” “below,” “left,” “right,” “horizontal,” “vertical,” “up,” “down,” etc., are used merely for convenience in describing the various embodiments of the present disclosure. The embodiments of the present disclosure may be oriented in various ways. For example, the diagrams, apparatuses, etc., shown in the drawing figures may be flipped over, rotated by 90° in any direction, reversed, etc.

For purposes of the present disclosure, a value or property is “based” on a particular value, property, the satisfaction of a condition, or other factor, if that value is derived by performing a mathematical calculation or logical decision using that value, property or other factor.

For purposes of the present disclosure, it should be noted that to provide a more concise description, some of the quantitative expressions given herein are not qualified with the term “about.” It is understood that whether the term “about” is used explicitly or not, every quantity given herein is meant to refer to the actual given value, and it is also meant to refer to the approximation to such given value that would reasonably be inferred based on the ordinary skill in the art, including approximations due to the experimental and/or measurement conditions for such given value.

For purposes of the present disclosure, the term “electrochemical cell” refers to a device capable of either generating electrical energy from chemical reactions or using electrical energy to cause chemical reactions.

For purposes of the present disclosure, the term “fuel cell” refers to an electrochemical cell that converts the chemical energy of a fuel (often hydrogen) and an oxidizing agent (often oxygen) into electricity through a pair of redox reactions. Fuel cells can produce electricity continuously for as long as fuel and oxygen are supplied. Disclosed embodiments may regard fuel cells as modular independent power modules that can generate power. A fuel cell uses the chemical energy of hydrogen or other fuels to cleanly and efficiently produce electricity. If hydrogen is the fuel, the only products are electricity, water, and heat. Fuel cells are unique in terms of the variety of their potential applications; they can use a wide range of fuels and feedstocks and can provide power for systems as large as a utility power station and as small as a laptop computer.

While the invention is susceptible to various modifications and alternative forms, specific embodiments thereof have been shown by way of example in the drawings and will be described in detail below. It should be understood, however that it is not intended to limit the invention to the particular forms disclosed, but on the contrary, the invention is to cover all modifications, equivalents, and alternatives falling within the spirit and the scope of the invention.

Disclosed aspects of the invention will discuss and address alternate methods of system-level steam control. Some aspects of the disclosed invention will discuss and address different methods of H₂ flow control. Disclosed embodiments work to reduce the overall system costs for SOEC systems and reduce H₂ wastage such as during SOEC hot stand-by.

Systems can utilize a steam control valve flow controller for providing steam control. Such systems may also attempt to provide H₂ flow control based on a mass flow controller at the HBB level. However, in accordance with some preferred designs of the disclosed invention, steam flow is controlled using pressure control (e.g., using a pressure regulator instead of a mass flow controller) and H₂ flow is controlled using a flow control orifice instead of a mass flow controller. The disclosed design facilitates reducing overall operational cost(s) while also reducing the amount of components employed within disclosed embodiments. In addition, disclosed embodiments seek to minimize the usage of stored H₂ necessary to operate the system.

As described below, embodiments of the disclosed invention address cold starting one aspect of the system (e.g., one HGM) until that aspect reaches a hydrogen producing state (i.e., full H₂ production). Then disclosed embodiments may utilize the produced H₂ to feed to other components of the disclosed system such as other HGMs and/or other HBBs, for example, to perform other additional cold start operations and/or provide H₂ flow to additional equipment, as needed.

In accordance with disclosed embodiments, solid oxide fuel cells (SOFC) can be operated as an electrolyzer in order to produce hydrogen and oxygen, referred to as solid oxide electrolyzer cells (SOEC). In SOFC mode, oxygen ions are transported from the cathode side (air) to the anode side (fuel) and the driving force is the chemical gradient of partial pressure of oxygen across the electrolyte. In SOEC mode, a positive potential is applied to the air side of the cell and the oxygen ions are now transported from the fuel side to the air side. Since the cathode and anode are reversed between SOFC and SOEC (i.e. SOFC cathode is SOEC anode, and SOFC anode is SOEC cathode), going forward, the SOFC cathode (SOEC anode) will be referred to as the air electrode, and the SOFC anode (SOEC cathode) will be referred to as the fuel electrode. During SOEC mode, water in the fuel stream is reduced (H₂O+2e⁻→O²⁻+H₂) to form H₂ gas and O²⁻ ions, O²⁻ ions are transported through the solid electrolyte, and then oxidized on the air side (O²⁻ to O₂) to produce molecular oxygen. Since the open circuit voltage for a SOFC operating with air and wet fuel (hydrogen, reformed natural gas) is on the order of .9 to 1V (depending on water content), the positive voltage applied to the air side electrode in SOEC mode raises the cell voltage up to typical operating voltages of 1.1 to 1.3V.

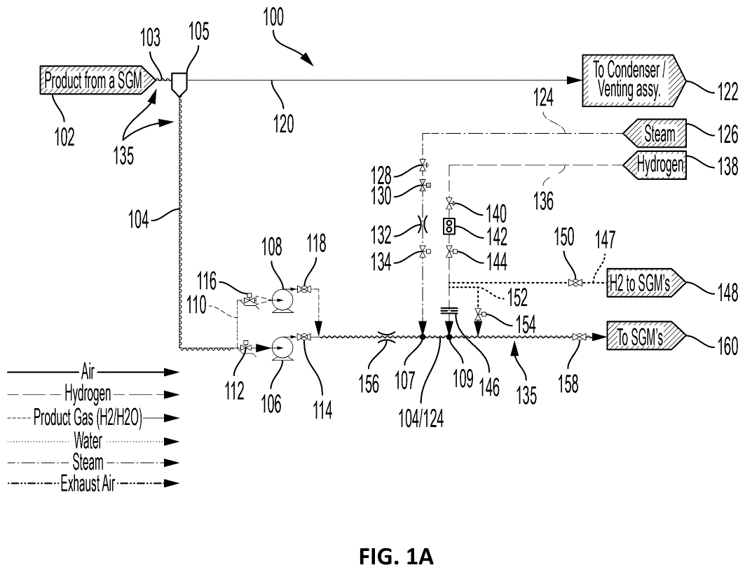

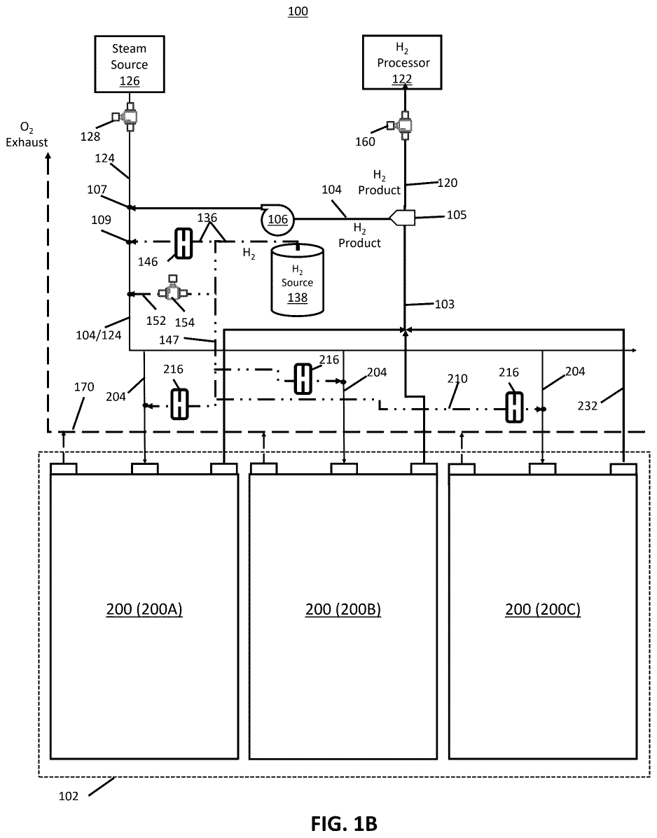

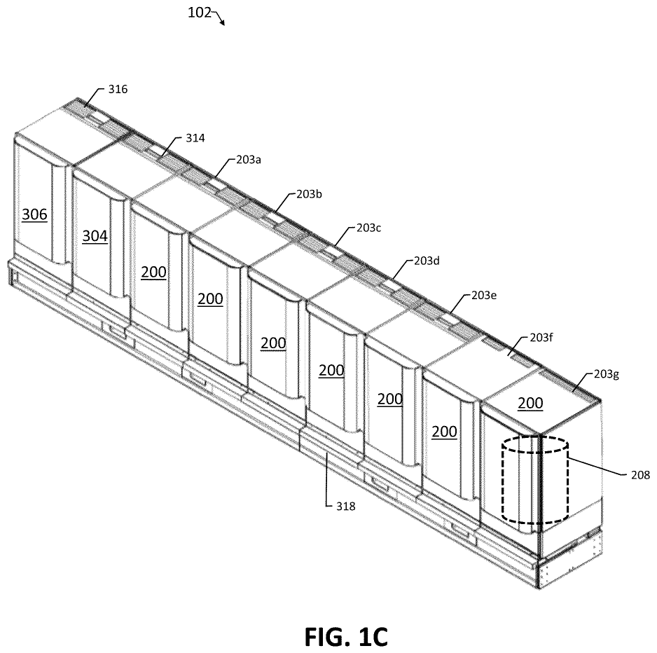

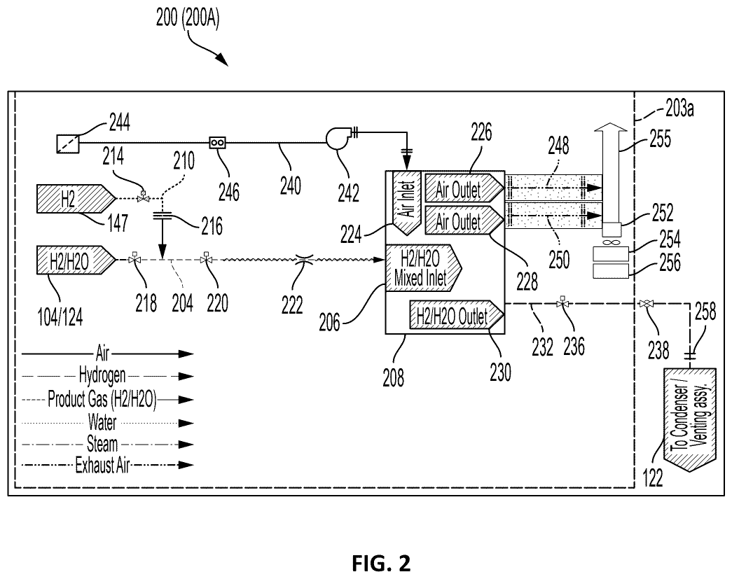

Turning to FIGS. 1A, 1B, 1C and 2, the dotted lines in FIGS. 1A-1C and 2 may be considered as optional embodiments of system operation(s). FIGS. 1A and 1B illustrate an HBB level solid oxide electrolyzer cell (SOEC) system 100 which may be operated based on pressure control, according to one embodiment of the present disclosure. A hydrogen-containing product feed, such as from one or more HGMs 102, is supplied and fed into system 100 along a supply conduit 103. FIG. 1B illustrates an embodiment of the system 100 in which the one or more HGMs 102 comprises a set 102 of plural HGMs 200 configured to provide the product feed into supply conduit 103. In some disclosed embodiments, the product feed may comprise H₂ or H₂/H₂O delivered through the supply conduit 103. In other words, substantially pure hydrogen or a mixture of hydrogen and residual steam (which was not converted to hydrogen) may be output as the hydrogen containing product from plural HGMs 102 to the supply conduit 103.

The system 100 of FIG. 1B may comprise a modular system in which the system components are located in separate module cabinets 203a-203g, 314 and 316, as shown in FIG. 1C. The components shown in FIG. 1C comprise one HBB. The HBB may optionally exclude the steam source 126, the hydrogen processor system 122 and/or the hydrogen source 138, if one or more of these components is shared among plural HBBs. The HGMs 200 are located in respective cabinets 203a-203g. Each HGM 200 located in a respective cabinet 203a-203g comprises a hotbox 208 and balance of plant components (e.g., valves, conduits, blowers, sensors, etc.). The hotbox 208 houses one or more electrolyzer cell columns and various heat exchangers and electrolyzer heaters.

The system also includes at least one power conditioning module 304 and at least one gas distribution module 306. A module cabinet 314 contains the power conditioning module 304 housing electrical components, such as a rectifier. The power conditioning module 304 may also include DC-DC converters. Alternatively, dedicated HGM DC-DC converters may be located in each respective module cabinet 203a-203g. Thus, the system 100 power conditioning system may be located in the cabinet 314 for the power conditioning module 304, in the cabinets 203a-203g for the HGMs 200, or in both the cabinet 314 for the power conditioning module 304 and in the cabinets 203a-203g for the HGMs 200. The module cabinet 316 contains a gas distribution module 306 housing steam processing and control components for the electrolyzer system 100. In one embodiment, the module cabinets 203a-203g, 314 and/or 316 are located on the same base 318. Alternatively, the cabinet 316 may be located on a separate base. The base 318 may comprise a concrete base and/or a skid containing passages for various fluid and electrical connections between the cabinets.

Referring back to FIGS. 1A and 1B, the supply conduit 103 includes a splitter 105 which splits the supply conduit 103 into a recycling conduit 104 and a product conduit 120. One or more blowers 106 may be connected to the recycle conduit 104.

In one disclosed configuration shown in FIG. 1A, a primary recycle blower 106 is operated as the primary blower for SOEC system 100. In the event that primary recycle blower 106 goes offline or malfunctions, a secondary recycle blower 108 is provided to service supply of the product feed without SOEC system 100 losing downtime, as further described below. Thus, providing blower redundancy in the disclosed embodiment works to avoid a single point failure. Disclosed embodiments may include another blower running in parallel or the additional secondary recycle blower 108 may be configured to run in a stand-by mode, for example, starting up if primary recycle blower 106 fails.

An appropriate monitoring system may be employed to monitor characteristics of the recycling conduit 104 such as product flow and pressure. In an exemplary embodiment, the aforementioned monitoring system may be configured to monitor primary recycle blower 106 to determine irregularities and/or failure in performance. For example, if primary recycle blower 106 fails to perform properly or goes offline, the monitoring system is capable of automatically enabling a secondary recycle blower 108 to come online without losing productivity of SOEC system 100. A backup supply conduit 110 may be connected from recycling conduit 104 to secondary recycle blower 108 and then back to recycling conduit 104 to bypass primary recycle blower 106, as shown in FIG. 1A. Valves 112, 114 may be connected to recycling conduit 104 before and after primary recycle blower 106, respectively. Likewise, valves 116, 118 may be connected along backup supply conduit 110 before and after secondary recycle blower 108, respectively.

Thus, the disclosed system is configured such that hydrogen flow is optimally not interrupted. Disclosed embodiments provide flexibility such that if one blower fails, a control system will automatically detect any failure and switch the operation to the other blower. Therefore, disclosed embodiments provide an ability to service the downed blower without interrupting overall system processes. Disclosed embodiments provide appropriate equipment, such as valve isolation equipment and control monitoring apparatus for monitoring upstream and downstream processes as needed.

While a primary recycle blower 106 and secondary recycle blower 108 have been described herein, it is readily appreciated that more blowers and associated capable monitoring systems may be implemented within the disclosed design for regulating and monitoring the disclosed system, as deemed necessary. Alternatively, the secondary recycle blower 108 may be omitted, as shown in FIG. 1B.

The product conduit 120 may be connected from one or more HGMs 102 via the supply conduit 103 to supply product feed (e.g., a hydrogen-containing product feed) to other equipment 122 (e.g., a hydrogen processor system, such as a condenser and/or venting assembly). A shutoff valve 160 (FIG. 1B) may be located on the product conduit 120.

A steam supply conduit 124 may be configured to supply steam from a steam source 126 to the recycling conduit 104. Additional equipment, may be connected to steam supply conduit 124, such as a steam flow regulator 128, a steam control valve 130, a steam flow meter 132, and an isolation valve 134. The steam flow regulator 128 comprises a pressure flow regulator which regulates the pressure of the steam flowing through the steam supply conduit 124. The steam supply conduit 124 and the recycling conduit 104 are merged at a first mixer (e.g., conduit junction) 107. A heater or heater coil 135 may be located adjacent to and/or wrapped around the supply conduit 103, the recycling conduit 104 and the merged recycling conduit and steam supply conduit 104/124.

A hydrogen supply conduit 136 may be configured to supply hydrogen from a hydrogen source 138 (e.g., fresh hydrogen source, such as a hydrogen storage vessel) to the merged recycling conduit and steam supply conduit 104/124 downstream of the first mixer 107. For example, the hydrogen supply conduit 136 may be connected to the merged recycling conduit and steam supply conduit 104/124 at a second mixer 109 located downstream of the first mixer 107. Alternatively, the hydrogen supply conduit 136 may be connected to the first mixer 107, or to one or both of the recycling conduit 104 and/or the steam supply conduit 124 upstream of the first mixer 107. Additional equipment, may be connected to hydrogen supply conduit 136 such as an optional hydrogen flow regulator (e.g., pressure flow regulator) 140, a fuel flow meter (FFM) 142, an isolation valve 144, and an orifice 146. The orifice may comprise a flow restrictor containing a restrictor plate and one or more orifices therein configured to create a predetermined amount of pressure drop in the hydrogen stream passing through the at least one orifice in the restrictor plate, such that a constant hydrogen flow rate is provided through the orifice 146 at a given constant incoming hydrogen pressure. In an optional embodiment, a mass flow controller may be provided on the hydrogen supply conduit 136 to control hydrogen flow at the HBB level as described below.

Embodiments of the disclosed SOEC system 100 may also comprise an optional hydrogen return conduit 147 configured to return hydrogen from hydrogen supply conduit 136 to additional equipment 148, such as to other HGMs 200 or the same HGMs 200, as shown in FIG. 1B. The supply of hydrogen to equipment 148 may be enabled (i.e., turned on) or terminated (i.e., turned off) through hydrogen return conduit 147 using a valve 150.

An alternate hydrogen return conduit 152 may be configured to supply hydrogen from hydrogen supply conduit 136 to merged recycling conduit and steam supply conduit 104/124 thus bypassing orifice 146. The supply of hydrogen to the merged recycling conduit and steam supply conduit 104/124 may be enabled (i.e., turned on) or terminated (i.e., turned off) through the alternate hydrogen return conduit 152 via valve 154.

Disclosed embodiments may provide additional instrumentation along the merged recycling conduit and steam supply conduit 104/124 including, for example, a fuel flow meter 156 and a valve 158. Ultimately, the merged recycling conduit and steam supply conduit 104/124 may supply a product (e.g., a hydrogen-containing product) and steam mixture to additional equipment 160, such as to the same HGMs 200 as the ones that generated the product, as shown in FIG. 1B, and/or to different one or more HGMs (e.g., HGMs located on a different base than the base 318 of the HGMs 200 shown in FIG. 1C).

An optional oxygen exhaust conduit 170 contains oxygen exhaust (e.g., pure oxygen or oxygen enriched air) from the plurality of HGMs 200. Alternatively, each HGM 200 may contain a separate oxygen exhaust and a common oxygen exhaust conduit 170 is omitted.

FIG. 2 illustrates an HGM 200 of the set 102 of the HGMs of the system 100 of FIGS. 1A-1C , according to an embodiment. The HGM 200 may be located in a cabinet 203a shown in FIG. 1C. The HGM 200 may receive fresh hydrogen directly from the hydrogen source 138 via the respective hydrogen return conduit 147 shown in FIGS. 1A and 1B. In one embodiment, the HGM 200 may receive both the fresh hydrogen via the hydrogen return conduit 147 and the mixture of hydrogen and steam from the merged recycling conduit and steam supply conduit 104/124 during the same operating mode or during different operating modes. Alternatively, the hydrogen return conduit 147 may be omitted, and the HGM 200 may receive only the mixture of hydrogen and steam from the merged recycling conduit and steam supply conduit 104/124 shown in FIGS. 1A and 1B.

Accordingly, the mixture of hydrogen and steam (“product feed”) from the merged recycling conduit and steam supply conduit 104/124 is supplied and fed into HGM 200 through a supply conduit 204 of the HGM 200. In some disclosed embodiments, the product feed may comprise H₂ and/or a mixture of H₂ and H₂O delivered through supply conduit 204. Supply conduit 204 may be configured to deliver the product feed directly to a hotbox 208 via inlet 206. In some embodiments, inlet 206 is configured as a mixed inlet which receives the mixture of hydrogen and steam.

The hydrogen return conduit 147 provides the fresh hydrogen to a hydrogen supply conduit 210 of the HGM 200. The hydrogen supply conduit 210 is connected to the supply conduit 204 to provide the fresh hydrogen from the hydrogen source 138 (e.g., fresh hydrogen source) to the supply conduit 204. Additional equipment, may be connected to hydrogen supply conduit 210, such as a valve 214 and an orifice 216. In the embodiments in which the fresh hydrogen is provided directly to the HGMs 200 and bypasses the system 100 level orifice 146 on the system 100 level hydrogen supply conduit 136, the orifice 216 located on the hydrogen supply conduit 210 inside the HGM 200 controls the pressure of the fresh hydrogen at the module level. Conduits 204, 210 and orifices 216 may be located inside the cabinets 203a-203g, as shown in FIG. 2, or outside the cabinets 203a-203g as shown in FIG. 1B.

One or more elements may be connected along supply conduit 204. For example, in one disclosed embodiment, control valves 218, 220 may be disposed along supply conduit 204 before and after (i.e., up steam and downstream from) the connection with hydrogen supply conduit 210, respectively. A fuel flow meter 222 may also be located on the supply conduit 204.

The hotbox 208 may also comprise an air inlet 224, one or more air outlets 226, 228 and a product (i.e., H₂/H₂O mixture) outlet 230. A product outlet flow conduit 232 may be connected to the product outlet 230 to supply the hydrogen-containing product (i.e., the H₂/H₂O mixture) to other the hydrogen processor system 122 (e.g., such as to a condenser and/or venting assembly) via a flange connection 258. Various instrumentation may be connected to the product outlet flow conduit 232, such as a valve 236 located in the cabinet 203a and a manual ball valve (MBV) 238 located outside the cabinet 203a for manual product shutoff.

An air supply conduit 240 may supply air to an air inlet 224 of the hotbox 208. In one disclosed embodiment, an air blower or pump 242 facilitates air flow through the air supply conduit 240. The air intake into the air blower or pump 242 may pass through an air filter 244. An air flow meter 246 may be located on the air supply conduit 240.

Air exhaust conduits 248, 250 are connected to the respective hotbox air outlets 226, 228. Air filters 254, 256 may be located in the air exhaust conduits 248, 250, respectively. The air exhaust conduits 248, 250 are connected to an air exhaust duct 255. An exhaust fan 252 may be located in the air exhaust duct 255. The exhaust fan 252 may comprise a feedback controlled fan. The oxygen exhaust from the SOEC columns exits the hotbox 208 via the respective hotbox air outlets 226, 228 and the respective air exhaust conduits 248, 250 into the air exhaust duct 255. The oxygen exhaust may exit the duct 255 to atmosphere or to the system oxygen exhaust conduit 170.

An exemplary operation of the disclosed system 100 including HGM 200 is described as follows. An H₂ flow and steam flow may be set using a pressure regulator at the HBB level (i.e., using the pressure regulator 128 at the system 100 level). The regulator 128 may be set to meet the maximum flow required per HBB from the cold start of the system. The steam pressure regulator 128 and the H₂ regulator (e.g., orifice(s) 146 and/or 216) may be set to meet the maximum flow required per HBB. A system purge may be provided to further prepare the system 100 to start generating hydrogen from steam. In some disclosed embodiments, this may require bleeding the air out of the system which may be accomplished by flowing hydrogen from the hydrogen source 138 as a purge gas through the system conduits to perform the air purge.

As part of a system start-up procedure (i.e., start-up mode), once the system is purged, the HGM 200 operation shifts from the from cold start (i.e., the start-up mode) to a steady-state operating mode at a temperature of approximately 700-760° C. in order to start to produce the hydrogen-containing product via electrolysis of steam (provided to the SOECs as pure steam or as a steam and hydrogen mixture) in the SOEC columns in the hotbox 208. The air from the air supply conduit 240 may be used as a sweep gas to remove oxygen from the air side electrodes of the SOECs in the SOEC columns.

Up to the steady-state operating mode, the system 100 receives fresh (e.g., pure) hydrogen from fresh hydrogen source 138 (such as a hydrogen tank), inputted into the system 100 to purge the air and to assist in the heat-up process for elevating a temperature of the system during the start-up mode. Specifically, the system 100 may be heated-up using one or more heaters. Once the steady-state temperature of the system 100 is achieved, the SOEC columns begin to generate hydrogen within the HGM 200 hotboxes 208. In accordance with disclosed embodiments, the system 100 may recycle back some of the hydrogen-containing product into the HGMs 200 via the recycling conduit 104 and send the remaining hydrogen-containing product to the hydrogen processor system 122 via the product conduit 120.

Disclosed embodiments provide a centralized recycling conduit 104 for a prescribed number of HGMs 200 (e.g., ranging from one to a multitude of HGMs). In the start-up mode, the shutoff valve 160 on the product conduit 120 is closed, such that no hydrogen is provided to the hydrogen processor system 122 from the HGMs 200. Thus, the fresh hydrogen is recycled to the HGM(s) through the recycling conduit 104 during the start-up mode, such that the total amount of fresh hydrogen from the hydrogen source 138 is reduced during the start-up mode. If one HGM 200 is used, then the recycling occurs through the recycling conduit 104 located outside of the cabinet 203a of the HGM 200. If plural HGMs 200 are used, then the recycling occurs through the recycling conduit 104 located outside of the cabinets 203a-203g of the plural HGMs 200.

The number of HGMs may be expanded, for example, based on the size and scale of equipment implemented. For example, servicing the amount of HGMs may be determined by the size of the recycle blower and how much hydrogen is cycled back into the system. Thus, disclosed embodiments provide: (1) cost reduction by centralizing the recycling conduit 104 at the system level 100, (2) capability for feeding the HGM's that are in need of hydrogen in order to start and/or maintain a hydrogen generation state by utilizing the HGMs on the same recycling conduit 104 that are generating hydrogen, and also (3) capability to tie into a system level product conduit 120 for supplying hydrogen for specialized use to the hydrogen processor system 122. The disclosed embodiments provide an independent yet efficient system 100 that reduces dependence on a fresh hydrogen supply source 138 for input into the electrolyzer modules (HGMs) 200 of the system 100.

In another embodiment, at least one HGM that has achieved the steady-state hydrogen generation mode feeds the hydrogen-containing product through the recycling conduit 104 into other HGMs that are operating in the start-up mode and require fresh hydrogen in order to purge air and reach the steady-state operating temperature to generate hydrogen. For example, referring to FIG. 1B, the shutoff valve 160 on the product conduit 120 is closed while one HGM 200 (e.g., 200A) is generating a hydrogen-containing product from steam in the steady-state operating mode, while the other HGMs 200 (e.g., 200B and 200C) are operating in the start-up mode. The hydrogen-containing product is provided from the first HGM 200A through the supply conduit 103 and the recycling conduit 104 to the supply conduits 204 of the other HGMs 200B, 200C.

Thus, the disclosed embodiments may feed hydrogen to individual HGMs from each other. This disclosed design also diminishes costs by greatly reducing the amount of hydrogen and hydrogen storage equipment that would otherwise be needed to store on site. The disclosed design moves away from modularity, because it incorporates a common recycling conduit. As one module is started up and is generating hydrogen, disclosed embodiments may utilize the output from that module to start-up additional modules. Thus, especially for large installations, disclosed embodiments may provide effective cost reductions in addition to speeding up start times up as well. This addresses large installations for reducing overall costs and improving margins.

While disclosed embodiments may utilize at least some of the hydrogen that one HGM is producing, the disclosed system remains efficient in that, at least initially, the use of produced hydrogen is being utilized to start other HGMs of the disclosed system. For example, after a first HGM has undergone a cold start process and that first HGM reaches the steady-state hydrogen producing operating, some of the first HGM's hydrogen may be recycled and supplied to cold start another HGM, for example, as part of its initial “heat-up” procedure. Thus, even though some hydrogen may be supplied to initially start up an initial HGM, employing the disclosed recycling conduit to start up other HGMs, such as in a large scaled-up operation, provides the ability to utilize recycled hydrogen in a manner that may greatly reduce operating costs. This is because separately stored individual hydrogen supplies and storage equipment for each and every modular configuration of HGMs that would otherwise be used to run and maintain HGM and HGM systems, for example, for cold start procedures, is not required.

In addition to the disclosed system level recycling conduit, because some embodiments provide system level hydrogen input control into individual modules, disclosed embodiments may move away from having individual mass flow controllers located in individual HGMs. Thus, instead of utilizing otherwise expensive mass flow controllers in individual modules, disclosed embodiments provide a common implemented design including a passive orifice 146 or 216 on a hydrogen inlet conduit. Embodiments provide a single set of fresh hydrogen supplied to individual modules from the common hydrogen source 138. In alternative embodiments, the orifice may be replaced with a mass flow controller and inputted into the HGMs as needed.

Disclosed embodiments may allow hydrogen to flow on the product side of the SOECs, such as from a storage tank (e.g., hydrogen source 138). This will reduce or prevent oxidation during the start-up mode. In conventional HGM systems, the H₂ flow is typically controlled using a mass flow controller. However, disclosed embodiments may control H₂ flow using an orifice 146 at the HBB level or an orifice 216 at the HGM level as depicted in FIGS. 1A, 1B and 2, respectively. Additionally, disclosed embodiments may recycle greater than 99% of the hydrogen-containing product stream (such as from one or more HGMs 102) into the recycling conduit 104. Recycling conduit 104 may also capture stored H₂ (such as from the hydrogen source 138) and/or steam (such as from steam source 126). Thus, the recycled product stream, the stored H₂ and/or steam provided through recycling conduit 104 to another HGM's hotbox 208 steam inlet 206 reduces waste of stored H₂ that would otherwise be used start-up comparative systems. Thus, the disclosed embodiments provide alternate ways to reduce the usage of stored H₂ by: 1) starting an original HGM 200A until it reaches H₂ production; 2) once the original HGM 200A starts producing H₂, then other HGM's 200B, 200C may utilize the H₂ generated from the production of the original HGM 200A. For multiple HGMs requiring a start-up procedure, the disclosed configuration reduces the amount of H₂ otherwise required, for example, from a hydrogen source 138. This effectively reduces the size of the hydrogen source (e.g., H₂ tank) 138 and the frequency of its resupply.

After the system 100 completes the steady-state mode in which it generates the hydrogen-containing product, it may be controlled to enter the shutdown mode. During the shutdown mode, hydrogen may flow on the product side of the electrolyzer cells (i.e., on the side of the fuel electrodes of the electrolyzer cells, such as the cathodes of SOECs) of the electrolyzer cell stacks or columns from the hydrogen source (e.g., hydrogen storage tank) 138 during the shutdown mode to prevent oxidation of nickel in nickel-cermet fuel electrodes of SOECs. During the shutdown mode, the shutoff valve 160 may be closed, and greater than 99% of the product outlet side stream (e.g., the stored H₂ and steam) from the outlet of the HGMs is recycled to inlets of the HGMs via the recycling conduit 104. This helps to reduce waste of the stored H₂.

In alternative embodiments, an alternate way to reduce the usage of the stored H during the shutdown mode is by providing hydrogen produced by one HGM 200A to other HGMs 200B, 200C which are not producing hydrogen, similar to the process described above with respect to the start-up mode. For example, when multiple HGMs are running in production, disclosed embodiments may allow one HGM 200A to remain in H₂ production mode (e.g., the steady-state mode) while shutting down the other HGMs 200B, 200C. Then other HGMs 200B, 200C may use the H2 generated by the HGM 200A operating in the steady-state mode (i.e., in the H2 production state). Once the other HGMs 200B, 200C are shutdown, the first HGM 200A may be shutdown using stored hydrogen flow from the hydrogen source 138 during its shutdown mode. This will assist to reduce the size of the hydrogen source (e.g., H₂ tank) 138 and the usage of stored H₂ will be less in comparison, for example, with multiple HGM's going through shutdown process at the same time.

During a hot standby mode, no hydrogen production occurs in the HGMs and the SOEC stacks or columns may need to be maintained at an elevated temperature that may be the same as or close to the steady-state mode temperature. While maintaining the stack or column elevated temperature using heaters, H₂ flow is preferably used to prevent oxidation of the nickel in the nickel cermet fuel electrodes of the SEOCs. Disclosed embodiments may be implemented in order to minimize the waste of stored H₂ including: 1) operating the HGM in dead end mode by closing the shutoff valve 160 on the product conduit 120, such that the dead end mode operates based on the downstream pressure; 2) flow the H₂ from the hydrogen source 138 based on the open circuit voltage (OCV) of the SOEC stacks or columns; and 3) provide a constant H₂ flow from the hydrogen source 138 and recycle>99% of the H2 back to the HGMs 200 using the recycling conduit 104 and the primary recycle blower 106. During the dead end mode, the HGMs 200 may still generate hydrogen from steam, and recycling the generated hydrogen and steam using the recycling conduit 104 and the primary recycle blower 106. During the OCV mode, the SOEC stack or column OCV is measured by a sensor or determined by the system power control electronics. The isolation valve (e.g., gas solenoid valve) 144 on the hydrogen supply conduit 136 is turned on when the measured voltage reaches a minimum “turn-on” threshold voltage. This allows hydrogen to flow to the SOECs from the hydrogen source 138 via the hydrogen supply conduit 136 to maintain a minimum stack or column OCV to prevent oxidation of the nickel in the fuel electrodes of the SOECs. Once the OCV increases above a certain maximum “turn-off” threshold voltage, the isolation valve 144 on the hydrogen supply conduit 136 is turned off, and the stored hydrogen flow to the SOECs stops, until the OCV again drops to the minimum “turn-on” voltage.

Disclosed embodiments also provide steady-state mode system 100 operation. While producing H₂ at steady state, part of the product H₂ (non-condensed) from the HGMs 200 may be recycled back to the steam inlet of the HGMs 200 at the HBB level (i.e., using the system level recycling conduit 104 and recycle blower 106) to increase net water utilization to 90%. The primary recycle blower 106 may be used to pull the hydrogen-containing product stream (e.g., via the recycling conduit 104) to mix with a fresh steam from the steam source 120 provided via conduit 124 at the HBB level (i.e., at the system 100 level outside the HGM 200 cabinets 203a-203g). In some disclosed embodiments, to prevent condensation on the supply conduit 103 and the recycling conduits 104, a heater or heater coil 135 may be placed on these conduits. The disclosed heat trace may turn on based on the fluid temperature in these conduits 103, 104.

In the HBB level system 100, the primary recycle blower 106 may recycle part of the hydrogen-containing product stream from the HGMs 200 in order to increase the water utilization. The mass flow controller and primary recycle blower 106 may be removed at the HGM 200 level (e.g., from the inside of the HGM 200 cabinets 203a-203g shown in FIGS. 1C and 2). According to disclosed embodiments, H₂ flow may be controlled using orifice 146 or optionally a mass flow controller at the HBB level (e.g., at the system 100 of FIGS. 1A and 1B outside the HGM cabinets 203a-203b). The H₂ flow can also be controlled using an orifice 216 at HGM level (e.g., inside the HGM cabinet 203a as shown in FIG. 2). The primary method of steam flow control is based on the steam consumption at the HGMs 200 based on the pressure using the pressure regulator 218. Steam flow may be measured at the HGMs using the venturi effect. Alternatively, the steam flow may be controlled at the HBB level using a steam control valve (SCV) 130, as shown in FIG. 1A. The inlet steam/H₂ plumbing may be optimized to reduce the backpressure from each HGM, such as those employed by the disclosed system. Maintaining the same backpressure from each HGM will ensure the same amount of flow to each HGM. Isolation valves such as valve 236 and/or valve 238 located outside the cabinets 203a-203g may be used by service personnel to shut off the hydrogen-containing product flow from a HGM 200A being serviced, while the other HGMs 200B, 200C may remain operational and may generate hydrogen while the first HGM 200A is being serviced.

In accordance with disclosed embodiments, the disclosed HBB level operation may have a potential benefit on modularity designs. For example, based on some site requirements, a number of HGMs may be added to a site such that a site-specific design for H₂ storage may no longer be required.

Disclosed embodiments provide enhanced operability and continuous functionality for high-level continuous operation. For example, in an instance where primary recycle blower 106 fails, the disclosed control system will switch the recycle operation to secondary recycle blower 108 by opening the valve 116 and closing valve 112 and vice-versa. A deployed service team may replace, fix and/or address any faulty equipment without stopping the overall system operation using the isolation valves 112, 114, 116, and 118.

It is noted that similar disclosed concepts may be extended to two or more HBB level designs. In-order to operate the second HBB, the inlet plumbing and outlet plumbing is preferably optimized to reduce the backpressure from the HGMs.

The approach of the disclosed embodiments supports operator selected efficiency. Because an operator may select something less than 100% output of the disclosed system, this would accommodate something less than 100% output going for customer use. Thus, the disclosed embodiments have the ability to operate at less than 100% efficiency. That requirement is under the customer control. Thus, the disclosed design supports variable output under operator control.

According to an aspect of the present disclosure illustrated in FIGS. 1A and 1B, an electrolyzer system 100 comprises a plurality of hydrogen generation modules (HGMs) 200, each containing at least one electrolyzer cell stack or column of stacks configured to electrolyze steam to generate hydrogen and oxygen; a steam supply conduit 124 configured to provide steam from a steam source 126 to the plurality of HGMs 200; a hydrogen supply conduit 136 configured to provide hydrogen from a hydrogen source 138 to the plurality of HGMs 200; a recycling conduit 104 configured to recycle at least a first portion of the hydrogen-containing product stream from the plurality of HGMs 200 back to the plurality of HGMs 200; and a product conduit 120 configured to receive a second portion of the hydrogen-containing product stream from the plurality of HGMs 200. The system 100 also comprises at least one of: (a) a primary recycle blower 106 located on the recycling conduit 104 outside of the plurality of HGMs 200 and configured to recycle at least the first portion of the hydrogen-containing product stream from the plurality of HGMs back to the plurality of HGMs 200 through the recycling conduit 104; (b) a steam pressure regulator 128 located on the steam supply conduit 124 and configured to control steam flow to the plurality of HGMs 200 using pressure control; or (c) an orifice 146 located on the hydrogen supply conduit 136 and configured to control hydrogen flow through the hydrogen supply conduit to the plurality of HGMs 200.

In one embodiment, the system 100 comprises any two, such as all three of the elements (a), (b) and (c). In one embodiment shown in FIG. 1C, each of the plurality of HGMs 200 comprises a respective cabinet 203a-203g containing a hotbox 208, and each hotbox 208 encloses at least one electrolyzer cell stack or column of stacks. In one embodiment, the steam supply conduit 124 is fluidly connected to the steam source 126 and to a steam inlet 206 of each hotbox 208 of each of the plurality of HGMs 200 via respective conduits 204, as shown in FIGS. 1A, 1B and 2. The hydrogen supply conduit 136 is fluidly connected to the hydrogen source 138 and to the steam inlet 206 of each hotbox 208 of each of the plurality of HGMs 200 via respective conduits 204 and/or 214. The recycling conduit 104 is fluidly connected to a product outlet 230 and the steam inlet 206 of each hotbox 208 of each of the plurality of HGMs 200 via respective conduits 103, 232 and 204. The product conduit 120 is fluidly connected to the product outlet 230 of each hotbox of each of the plurality of HGMs via conduits 232 and 103 and to the hydrogen processor system 122.

In one embodiment, the system 100 also includes a monitoring and control system configured to monitor and control hydrogen flow from the hydrogen source 138 and steam flow from the steam source 126 based on pressure of the system. In one embodiment, the system also includes a secondary blower fluidly connected to the recycling conduit to allow for bypass of the primary blower 108 shown in FIG. 1A. The monitoring and control system is configured to operate the secondary blower 108 when the primary blower 106 is not operating.

In one embodiment, the system 100 further comprises a hydrogen return conduit 147 fluidly connected to the hydrogen supply conduit 136 upstream of the orifice 146 and fluidly connected to a first HGM 200A of the plurality of the HGMs 200A, 200B, 200C and configured to supply the hydrogen to the first HGM 200A; and a module level orifice 216 located on the hydrogen return conduit 147/214 in the first HGM 200A.

In one embodiment, a method of operating the electrolyzer system 100 includes providing steam to a plurality of hydrogen generation modules (HGMs) 200, each containing at least one electrolyzer cell stack or column of stacks, electrolyzing the steam in the plurality of HGMs to generate hydrogen and oxygen, supplying at least a first portion of a hydrogen-containing product feed from the plurality of HGMs to a recycling conduit 104, and recycling at least a first portion of the hydrogen-containing product feed to the plurality of HGMs 200.

In one embodiment, the method further comprises regulating a pressure of the steam provided to the plurality of HGMs using a steam pressure regulator 128 located on the steam conduit 124. In one embodiment, the hydrogen-containing product feed comprises the generated hydrogen and a remaining portion of the steam that is not electrolyzed.

In one embodiment, the step of recycling at least the first portion of the hydrogen-containing product feed to the plurality of HGMs 200 comprises using a primary recycle blower 106 located on the recycling conduit 104 to recycle the at least the first portion of the hydrogen-containing product feed to the plurality of HGMs 200. In one embodiment, the method also includes using a secondary recycle blower 108 located on the recycling conduit 104 to recycle the at least the first portion of the hydrogen-containing product feed to the plurality of HGMs 200 when the primary recycle blower 106 is not operating. In one embodiment, the method also includes providing at least a second portion of the hydrogen-containing product feed to a hydrogen processor system 122 using the product conduit 120.

In one embodiment, the method also includes operating the system in a hot standby mode by: terminating providing the second portion of the hydrogen-containing product feed the hydrogen processor system 122; recycling all of the hydrogen-containing product feed to the plurality of HGMs 200; and heating the at least one electrolyzer cell stack or column of stacks using at least one heater.

In an alternative embodiment, the method also includes operating the system in a hot standby open circuit voltage (OCV) mode by: determining the OCV of the at least one electrolyzer cell stack or column of stacks using a sensor or the system's power electronics; flowing fresh hydrogen to the plurality of HGMs when the OCV reaches a minimum threshold voltage; and terminating the flowing fresh hydrogen to the plurality of HGMs 200 when the OCV reaches a maximum threshold voltage.

In one embodiment, the method also includes providing fresh hydrogen from the hydrogen source 138 to the plurality of HGMs 200. The fresh hydrogen may be provided through an orifice 146 or 216. In one embodiment, the steps of providing the steam to the plurality of HGMs 200 and the electrolyzing the steam in the plurality of HGMs occurs during a steady-state operating mode, while the step of providing fresh hydrogen to the plurality of HGMs 200 occurs during a start-up mode which precedes the steady-state operating mode and/or during a shutdown mode which follows the steady-state operating mode.

In one embodiment, the method also includes recycling at least 99% of the fresh hydrogen to the plurality of HGMs 200 through the recycling conduit 104 during the start-up mode and during the shutdown mode.

In an alternative embodiment, the method also includes providing the fresh hydrogen to a first HGM 200A of the plurality of HGMs 200A-200C during the start-up mode until the first HGM reaches 200 the steady-state operating mode; providing the steam to the first HGM 200A operating in the steady-state operating mode; and providing the hydrogen-containing product from the first HGM 200A to at least a second HGM 200B and/or 200C of the plurality of HGMs 200A-200C operating in the start-up mode until the second HGM 200B and/or 200C reaches the steady-state operating mode. The method also includes providing the steam to the first HGM 200A while the first HGM is operating in the steady-state operating mode; providing the hydrogen-containing product from the first HGM 200A operating in the steady-state operating mode to at least a second HGM 200B and/or 200C of the plurality of HGMs 200A-200C operating in the shutdown mode until the second HGM 200B and/or 200C is shut down; and after the second HGM 200B and/or 200C is shut down, providing the fresh hydrogen to the first HGM 200A while the first HGM 200A operates in the shutdown mode.

Electrolyzer systems of the embodiments of the present disclosure are designed to reduce greenhouse gas emissions and have a positive impact on the climate.

The preceding description of the disclosed aspects is provided to enable any person skilled in the art to make or use the present invention. Various modifications to these aspects will be readily apparent to those skilled in the art, and the generic principles defined herein may be applied to other aspects without departing from the scope of the invention. Thus, the present invention is not intended to be limited to the aspects shown herein but is to be accorded the widest scope consistent with the principles and novel features disclosed herein.

What is claimed is:

1. An electrolyzer system, comprising:
a plurality of hydrogen generation modules (HGMs), each containing at least one electrolyzer cell stack or column of stacks configured to electrolyze steam to generate hydrogen and oxygen;
a steam supply conduit configured to provide steam from a steam source to the plurality of HGMs;
a hydrogen supply conduit configured to provide hydrogen from a hydrogen source to the plurality of HGMs;
a recycling conduit configured to recycle at least a first portion of the hydrogen-containing product stream from the plurality of HGMs back to the plurality of HGMs;
a product conduit configured to receive a second portion of the hydrogen-containing product stream from the plurality of HGMs; and
at least one of:
(a) a primary recycle blower located on the recycling conduit outside of the plurality of HGMs and configured to recycle at least the first portion of the hydrogen-containing product stream from the plurality of HGMs back to the plurality of HGMs through the recycling conduit;
(b) a steam pressure regulator located on the steam supply conduit and configured to control steam flow to the plurality of HGMs using pressure control; or
(c) an orifice located on the hydrogen supply conduit and configured to control hydrogen flow through the hydrogen supply conduit to the plurality of HGMs.

2. The system of claim 1, wherein the system comprises the primary recycle blower.

3. The system of claim 1, wherein the system comprises the steam pressure regulator.

4. The system of claim 1, wherein the system comprises the orifice.

5. The system of claim 1, wherein the system comprises at least two of the primary recycle blower, the steam pressure regulator and the orifice.

6. The system of claim 5, wherein:
the system comprises all three of the primary recycle blower, the steam pressure regulator and the orifice; and
the at least one electrolyzer cell stack or column of stacks comprises at least one solid oxide electrolyzer cell stack or column of stacks.

7. The system of claim 1, wherein:
each of the plurality of HGMs comprises a respective cabinet containing a hotbox, and the hotbox encloses the at least one electrolyzer cell stack or column of stacks;
the steam supply conduit is fluidly connected to the steam source and to a steam inlet of the hotbox of each of the plurality of HGMs;
the hydrogen supply conduit is fluidly connected to the hydrogen source and to the steam inlet of the hotbox of each of the plurality of HGMs;
the recycling conduit is fluidly connected to a product outlet and the steam inlet of the hotbox of each of the plurality of HGMs; and
the product conduit is fluidly connected to the product outlet of the hotbox of each of the plurality of HGMs and to a hydrogen processor system.

8. The system of claim 2, further comprising:
a monitoring and control system configured to monitor and control hydrogen flow from the hydrogen source and steam flow from the steam source based on pressure of the electrolyzer system; and
a secondary blower fluidly connected to the recycling conduit to allow for bypass of the primary blower, wherein the monitoring and control system is configured to operate the secondary blower when the primary blower is not operating.

9. The system of claim 4, further comprising:
a hydrogen return conduit fluidly connected to the hydrogen supply conduit upstream of the orifice and fluidly connected to a first HGM of the plurality of the HGMs and configured to supply the hydrogen to the first HGM; and
a module level orifice located on the hydrogen return conduit in the first HGM.

10. A method of operating an electrolyzer system, comprising:
providing steam to a plurality of hydrogen generation modules (HGMs), each containing at least one electrolyzer cell stack or column of stacks;
electrolyzing the steam in the plurality of HGMs to generate hydrogen and oxygen;
supplying at least a first portion of a hydrogen-containing product feed from the plurality of HGMs to a recycling conduit; and
recycling at least a first portion of the hydrogen-containing product feed to the plurality of HGMs.

11. The method of claim 10, further comprising regulating a pressure of the steam provided to the plurality of HGMs using a steam pressure regulator.

12. The method of claim 10, wherein the hydrogen-containing product feed comprises the generated hydrogen and a remaining portion of the steam that is not electrolyzed.

13. The method of claim 12, wherein the recycling at least the first portion of the hydrogen-containing product feed to the plurality of HGMs comprises using a primary recycle blower located on the recycling conduit to recycle the at least the first portion of the hydrogen-containing product feed to the plurality of HGMs.

14. The method of claim 13, further comprising using a secondary recycle blower located on the recycling conduit to recycle the at least the first portion of the hydrogen-containing product feed to the plurality of HGMs when the primary recycle blower is not operating.

15. The method of claim 13, further comprising providing at least a second portion of the hydrogen-containing product feed to a hydrogen processor system.

16. The method of claim 15, further comprising operating the system in a hot standby mode by:
terminating providing the second portion of the hydrogen-containing product feed the hydrogen processor system;
recycling all of the hydrogen-containing product feed to the plurality of HGMs; and
heating the at least one electrolyzer cell stack or column of stacks using at least one heater.

17. The method of claim 10, further comprising providing fresh hydrogen to the plurality of HGMs.

18. The method of claim 17, wherein:
the steps of providing the steam to the plurality of HGMs and the electrolyzing the steam in the plurality of HGMs occurs during a steady-state operating mode; and
the step of providing fresh hydrogen to the plurality of HGMs occurs during a start-up mode which precedes the steady-state operating mode and during a shutdown mode which follows the steady-state operating mode.

19. The method of claim 18, further comprising recycling at least 99% of the fresh hydrogen to the plurality of HGMs through the recycling conduit during the start-up mode and during the shutdown mode.

20. The method of claim 18, further comprising:
providing the fresh hydrogen to a first HGM of the plurality of HGMs during the start-up mode until the first HGM reaches the steady-state operating mode;
providing the steam to the first HGM operating in the steady-state operating mode; and
providing the hydrogen-containing product from the first HGM to at least a second HGM of the plurality of HGMs operating in the start-up mode until the second HGM reaches the steady-state operating mode.

21. The method of claim 18, further comprising:
providing the steam to a first HGM of the plurality of HGMs while the first HGM is operating in the steady-state operating mode;
providing the hydrogen-containing product from the first HGM operating in the steady-state operating mode to at least a second HGM of the plurality of HGMs operating in the shutdown mode until the second HGM is shut down; and
after the second HGM is shut down, providing the fresh hydrogen to the first HGM while the first HGM operates in the shutdown mode.

22. The method of claim 17, wherein the fresh hydrogen is provided to the plurality of HGMs through an orifice.

23. The method of claim 10, further comprising operating the system in a hot standby open circuit voltage (OCV) mode by:
determining the OCV of the at least one electrolyzer cell stack or column of stacks;
flowing fresh hydrogen to the plurality of HGMs when the OCV reaches a minimum threshold voltage; and
terminating the flowing fresh hydrogen to the plurality of HGMs when the OCV reaches a maximum threshold voltage.
